(19) United States
(12) Patent Application Publication
(10) Pub. No.: US 2014/0317025 A1
(43) Pub. Date: Oct. 23, 2014

(54) Utility Equipment Monitoring and Reporting Systems and Methods

(71) Applicant: Utility Sentry, Inc., Owens Cross Road, AL (US)

(72) Inventors: Guy R. Monagas, Gastonia, NC (US); Jason Lee Cribbet, Owens Cross Roads, AL (US); Diana L. Monagas, Gastonia, NC (US); Roger L. McDonald, Charlottesville, VA (US); Scott J. Schnorrenberg, Hampton Cove, AL (US); Jason Holmes, Hampton Cove, AL (US)

(21) Appl. No.: 14/257,736

(22) Filed: Apr. 21, 2014

Related U.S. Application Data
(60) Provisional application No. 61/813,895, filed on Apr. 19, 2013.

(51) Int. Cl. G06Q 50/06; G06Q 20/14

(52) U.S. Cl. CPC G06Q 50/06; G06Q 20/145
USPC 705/412

(57) ABSTRACT

The present disclosure is an utility equipment monitoring and reporting system, that has a property comprising at least one utility and a third party data source coupled to the at least one utility that receives measurement data indicative of utility consumption. The system further has a data retrieval computing device that retrieves measurement data from the third party data source and transmits the measurement data to a server computing device via a network.

### CROSS-REFERENCE TO RELATED APPLICATION

This application claims priority to U.S. Provisional Patent Application Ser. No. 61/813,895 entitled Energy Equipment Monitoring and Reporting Systems and Methods filed on Apr. 19, 2013, which is incorporated herein by reference.

### BACKGROUND

Most habitable dwellings are provisioned with utilities. For example, most habitable dwellings comprise fixtures that necessarily require electricity or water to operate. In this regard, most dwellings have lights, appliances, showers, sinks, and the like. Utility facilities that provide water or electricity provide the utility on demand to most dwellings to ensure operation of these ordinary fixtures.

Typically, the utilities provided are metered or measured by quantity. For example, the wattage or amperage supplied the dwelling is measured or the amount of water provided to the dwelling is measured. The measurements taken of the provisions are then billed to the owner, operator, dweller, or inhabitant of the dwelling based upon the measurements taken. In this regard, electricity and water are billed by quantity to the end user.

During a billing cycle, one or more fixtures receiving the utility may not operate properly and may require more provisioning than normal. For example, a toilet may leak. In such a scenario, the quantity of water consumed will be higher than normal; however, the end user may be unaware of the malfunction until he/she receives a bill for the overuse.

### SUMMARY

The present disclosure is an utility equipment monitoring and reporting system that has a property comprising at least one utility and a third party data source coupled to the at least one utility that receives measurement data indicative of utility consumption. The system further has a data retrieval computing device that retrieves measurement data from the third party data source and transmits the measurement data to a server computing device via a network.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1A is a diagram depicting an exemplary utility equipment monitoring and reporting system for two separate and distinct properties in accordance with an embodiment of the present disclosure.

FIG. 1B is a diagram depicting an exemplary utility equipment monitoring and reporting system for a multiple family property in accordance with an embodiment of the present disclosure.

FIG. 1C is a diagram depicting an exemplary utility equipment monitoring and reporting system a hotel property in accordance with an embodiment of the present disclosure.

FIG. 2 is a diagram depicting an exemplary data retrieval device such as is depicted in FIGS. 1A, 1B, and 1C.

FIG. 3 is a diagram depicting an exemplary server computing device such as is depicted in FIGS. 1A, 1B, and 1C.

FIG. 4 is a diagram depicting an exemplary client computing device such as is depicted in FIGS. 1A, 1B, and 1C.

FIGS. 5-13 are exemplary graphical user interfaces (GUI) used in one embodiment the system depicted in FIG. 1B for a multiple family residence depicted in FIG. 1B.

FIGS. 14 and 15 are exemplary GUIs used in another embodiment of the system depicted in FIG. 1C for a hotel property in accordance with an embodiment of the present disclosure.

FIG. 16 is a flowchart depicting exemplary architecture and functionality of the system depicted in FIGS. 1A-1C.

### DETAILED DESCRIPTION

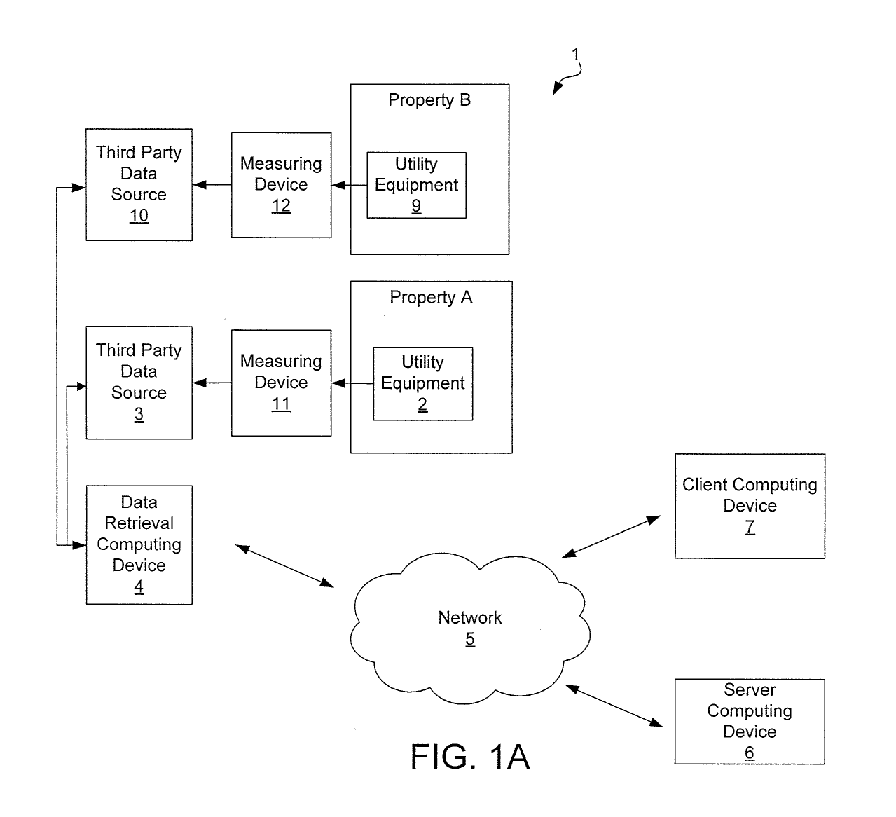

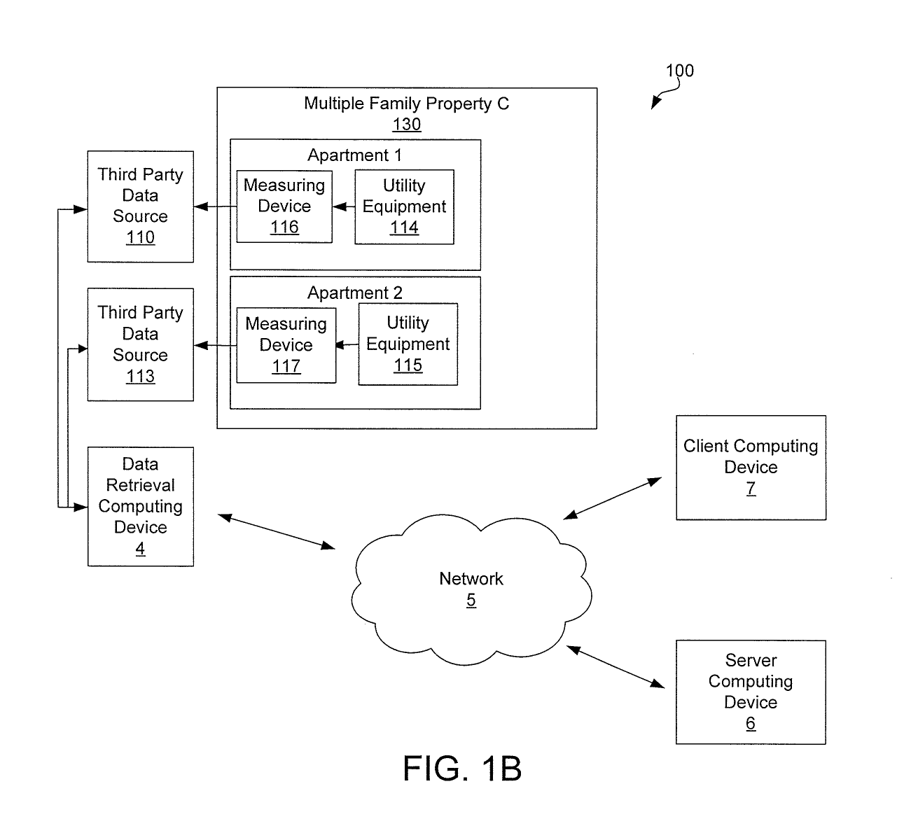

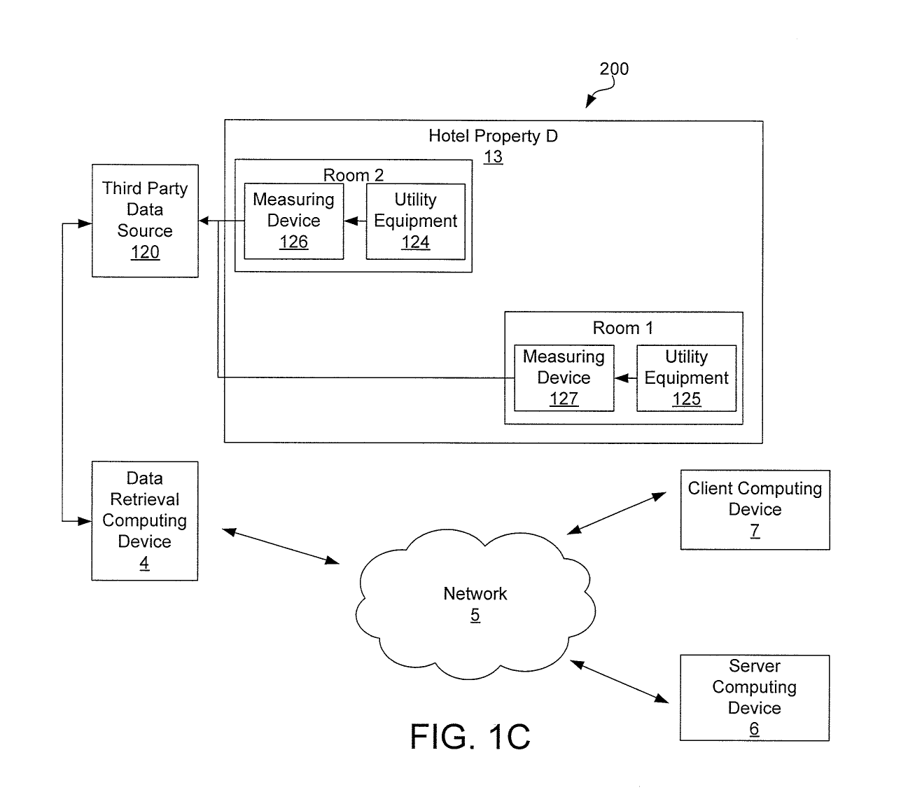

FIG. 1A is a block diagram illustrating an exemplary utility monitoring and reporting system 1 in accordance with an embodiment of the present disclosure for monitoring production utility equipment and reporting results of the monitoring as related to individual residences. In the embodiment shown, there are two single-family residences, including Property A and Property B.

In particular, equipment and/or particular devices are configured for providing utilities to each of Property A and Property B. Such utilities may encompass fixtures for the provision of water, gas, heating ventilation and air conditioning (HVAC) or power to a consumer premise. The Property A or B may be any type of facility that consumes the utility provided, including, but not limited to individual households, apartment complexes, office buildings, or arenas, e.g., stadiums or civic centers. FIG. 1A depicts an embodiment wherein two separate residential consumer premises are being monitored.

The utility monitoring and reporting system 1 comprises utility equipment 2, 9 that supplies a service (e.g., water, gas, HVAC and/or power) to at least one Property A or B. Further, as indicated hereinabove, the Property is not limited and may include individual households, apartment complexes, office buildings, hotels motels, or arenas, e.g., stadiums or civic centers, as mere examples, which are described further herein.

Note that two utility equipment instantiations 2, 9 are shown for exemplary purposes. In one embodiment, the utility equipment 2, 9 each supply some type of utility service to the Properties A and B, respectively. For example, the utility equipment 2 may supply power, whereas the utility equipment 9 may supply water. The utility equipment 2, 9 may be, for example, a toilet, a sink, a Heating, Ventilation, and Air Conditioning (HVAC) unit, or the like. The utility equipment 2, 9 may be light fixtures, appliances, or any instrumentation that provides electricity, gas, or water.

The utility equipment 2, 9 couples to measuring devices 11, 12, respectively. The measuring devices 11, 12 are any type of devices known in the art or future-developed for measuring a quantity of service provided to the Properties A or B. For example, the measuring device 11, 12 may be an electric meter, the type of which is often customary at a residence. In addition, the measuring device 11, 12 may be a water meter the, type of which is often customary at a residence. As will be described further herein, the measuring devices 11, 12 may be any type of meter transmission unit (MTU) that connects to any gas, water, or electric meter that provides an electronic output.

The electric meter may measure power usage and capture data indicative of the power usage at the residence. Whereas, the water meter may measure and capture data indicative of the amount of water that is being used at the residence.

The measuring devices 11, 12 are communicatively coupled to third party data sources 3, 10, respectively. The third party data sources 3, 10 are any type of computing device that interfaces with the measuring devices 11, 12, respectively, and retrieves data indicative of measurements made by the measuring devices 11, 12. Such third party data sources are often used to retrieve data from the measuring devices 11, 12 and transmit the data retrieved to a billing computing device, such as one located at central utilities responsible for billing. Exemplary submetering solutions that serve as data collectors for the third party data sources 10, 3 may include, but are not limited to TapWatch®, SpeedRead Technologies™, Tehama Wireless™, or Hexagram STAR®.

As a mere example, the utility equipment 9 may provide electricity to the Property A. In such an embodiment, the measuring device 12 is an electric meter that measures the voltage and current usage at the Property A by measuring activity of the utility equipment 9.

In addition, the equipment monitoring and reporting system 1 further comprises a data retrieval computing device 4. The data retrieval computing device 4 is any type of computing device known in the art or future-developed. For example, the data retrieval computing device 4 may be a laptop computer, a personal computer, a workstation, a server, a tablet, a smart phone, a personal digital assistant (PDA), a tablet, or the like.

In this regard, the data retrieval computing device 4 is any type of device that is configured to receive data indicative of utility consumption metered (or measured) by the measuring devices 11, 12 via the third party data sources 3, 10. For example, with respect to power as described hereinabove, the measuring devices 11, 12 may measure current and/or voltage over time in order to determine that amount of power consumed by the Properties A, B, which the third party data sources 3, 10 retrieve from the measuring devices 11, 12 and store for future use. The data retrieval computing device 4 retrieves such data from the third party data sources 3, 10 via phone, wireless, internet or future connection protocols. In one embodiment, the third party data sources 3, 10 may be configured to periodically transmit such data to the data retrieval computing device 4. Thus, the data retrieval device 4 may be hard-wired, for example via a serial connection, to the third party data sources 10, 3.

In other embodiments, the data retrieval device 4 may be wirelessly coupled to the data sources 10, 3. For example, the data retrieval device 4 and the data sources 10, 3 may employ Bluetooth or other type of wireless protocol through which the data retrieval device 4 may communicate with the data sources 10, 3. In such an embodiment, each of the data sources 10, 3 and the data retrieval device 4 may be equipped with a wireless transceiver for wirelessly transmitting and receiving signals, which is described in more detail hereinafter.

Note that utility equipment 2, 9 is directly coupled to measuring devices 11, 12 to ensure that the utility provided is accurately measured. Such accurate measurement is used for the purpose of billing the consumer (or entity) that is financially responsible for the Properties A, B. The data retrieval computing device 4 is configured to interface with the third party data sources 3, 10 and retrieve data indicative of the consumption information recorded by the measurement devices 11, 12. A number of devices may be used in order to obtain the consumption data from the utility equipment 9, 2. For example, the data retrieval computing device 4 may employ an optical character recognition device that retrieves the consumption data via assessment of text, which may include letters, words, or numbers. Additionally, the third party data sources 3, 10 may be configured with an electronic port for accessing data stored in memory (not shown) of the measuring devices 11, 12. In such a scenario, the third party data sources 3, 10 may comprise a device for connecting to the port and retrieving data from the measuring devices 11, 12.

The data retrieval computing device 4 is communicatively coupled to a server computing device 6 via a network 5. The network 5 may be any type of network configured to transmit data from the data retrieval computing device 4 to the server computing device 6. In this regard, the network 5 may be a collection of interconnected computers and/or other hardware that creates a communication channel between the data retrieval computing device 4 and the server computing device 6. As mere examples, the network may be a local area network (LAN) or a wide area network (WAN).

At periodic intervals (or via a continuous feed), the data retrieval computing device 4 transmits data indicative of the data retrieved from the third party data sources 3, to the server computing device 6. The server computing device 6 stores the received data correlated with a consumer premises identifier that specifically identifies the Property A, B, C, or D that is supplied utilities by the utility equipment 2, which is metered by the measuring devices 11, 12. In one embodiment, a user (not shown) may access the data via the server computing device 6.

In another embodiment, the equipment monitoring and reporting system 1 further comprises a client computing device 7. The client computing device 7 is any type of computing device 7 configured to access the data stored on the server computing device 6 via the network 5. As a mere example, the client computing device 7 may be a laptop, a handheld device, a personal computer, or a tablet that is used by a consumer associated with the Properties. The client computing device 7 may comprise a software program, an application (e.g., an “app”), or a web browser that is configured to retrieve (or receive) data from the server computing device 6 and display the data to the user.

Note that in the embodiment showing, each measuring device 11, 12 may have associated with it a unique identifier. The measuring device 11, 12 may be pre-populated at the time of manufacture either via firmware or dip switches. Also, the measuring device 11, 12 may be populated with unique identifier at installation via setting dip switches or transmitting electronically data to the measuring device 11, 12 identifying the unique identifier.

Further note that during communication between the measuring devices 11, 12 and corresponding third party data sources 10, 3 data indicative of the unique identifier may be transmitted along with the measurement data. Thus, the third party data source 10, 3 can receive the data and corresponding unique identifier and correlate the received data with the appropriate measuring device 11, 12.

FIG. 1B is a block diagram illustrating another exemplary equipment monitoring and reporting system 100 in accordance with an embodiment of the present disclosure for monitoring production utility equipment and reporting results of the monitoring as related to multi-resident complexes, such as for example an apartment complex or multiple family property C 130. This embodiment is similar to the embodiment depicted in FIG. 1A. However, the data collected for multiple residences may be relevant to a single entity, e.g., the apartment complex manager, which is described further herein. Thus, the data collected may be correlated with a single identifier related to the complex so that the data may be retrieved for each unit in the complex, which shall be described further herein.

In system 100, utility equipment 114, 115 are configured for providing utilities to each apartment, apartment 1 and apartment 2, respectively. Such utilities 114, 115 may encompass various services including provision of water, gas, heating ventilation and air conditioning (HVAC) or power to the apartment, i.e., Apartment 1 or Apartment 2.

Measuring device 116 measures utility usage of utility 114 and measuring device 117 measures utility usage of utility equipment 115. The measuring devices 116, 117 periodically or by request, tansmit data indicative of utility usage to the third party data sources 110 and 113. Note that two third party data sources 110, 13 are shown for exemplary purposes. Additional or fewer data sources may be used in other embodiments.

As is similar to system 1, in system 100 data retrieval computing device 4 retrieves the data from the third party data sources 110, 113 and transmits the data via the network 5 to the server computing device 6. The data is then accessible by the client computing device 7 via a web browser, for example, which is described further herein.

FIG. 1C is a block diagram illustrating another exemplary equipment monitoring and reporting system 200 in accordance with an embodiment of the present disclosure for monitoring production utility equipment and reporting results of the monitoring as related to Hotel Property D. This embodiment is similar to the embodiment depicted in FIG. 1A. However, the data collected for multiple rooms, and identified as such, may be relevant to a single entity, e.g., the hotel manager, which is described further herein. Thus, the data collected may be correlated with a single identifier related to the hotel so that the data may be retrieved for each unit in the complex, which shall be described further herein.

In system 200, utility equipment 124, 125 are configured for providing utilities to each room, Room 2 and Room 1, respectively. Note that only two rooms are shown but there may be additional or fewer rooms in other embodiments. Such utilities 124, 125 may encompass various services including provision of water, gas, heating ventilation and air conditioning (HVAC) or power to the hotel rooms, i.e., Room 1 or Room 2.

Measuring device 126 measures utility usage of utility 124 and measuring device 127 measures utility usage of utility equipment 125. The measuring devices 126, 127 periodically or by request, tansmit data indicative of utility usage to the third party data source 120. Note that one third party data source 120 is shown for exemplary purposes. Additional data sources may be used in other embodiments.

As is similar to system 1, in system 100 data retrieval computing device 4 retrieves the data from the third party data source 120 and transmits the data via the network 5 to the server computing device 6. The data is then accessible by the client computing device 7 via a web browser, for example, which is described further herein.

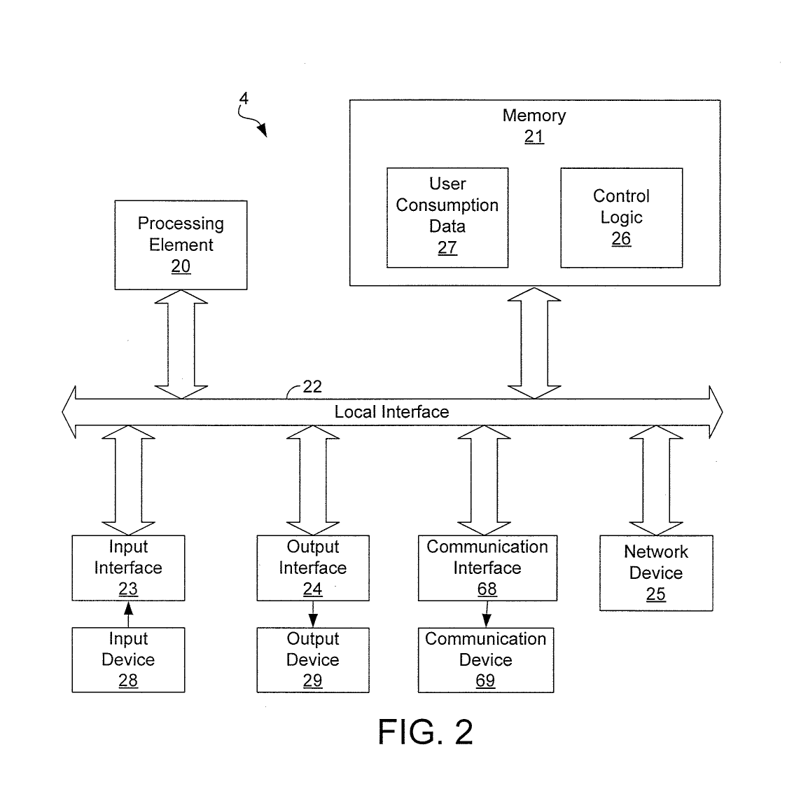

FIG. 2 depicts an exemplary embodiment of the data retrieval computing device 4 depicted in FIGS. 1A, 1B, and 1C. As shown by FIG. 2, the data retrieval computing device 4 comprises control logic 26 and user consumption data 27, which are stored in memory 21.

The control logic 26 generally controls the functionality of the data retrieval device 4, as will be described in more detail hereafter. It should be noted that the control logic 26 can be implemented in software, hardware, firmware or any combination thereof. In an exemplary embodiment illustrated in FIG. 2, the control logic 26 is implemented in software and stored in memory 21.

Note that the control logic 26, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the data retrieval computing device 4 depicted by FIG. 2 comprises at least one conventional processing element 20, such as a digital signal processor (DSP) or a central processing unit (CPU), that communicates to and drives the other elements within the data retrieval computing device 4 via a local interface 22, which can include at least one bus. Further, the processing element 20 is configured to execute instructions of software, such as the control logic 26.

An input interface 23 may be communicatively coupled to an input device 28, for example, a keyboard, keypad, or mouse. The input interface 23 may be used to receive signals from the input device 28 indicative of input data from a user of the data retrieval device 4.

Further, an output interface 24 may be communicatively coupled to an output device 29, for example, a printer or display screen (e.g., a liquid crystal display (LCD)). The output interface 24 may be used to transmit signals to the output device 29 indicative of output data to the user.

In addition, a network device 25, such as a modem, enables the data retrieval computing device 4 to communicate via the network 5 (FIG. 1) to other devices in communication with the network 5. As an example, the network device 25 enables the data retrieval computing device 4 to transmit to and receive data from the server computing device 6.

As indicated hereinabove, the user consumption data 27 is stored in memory 21. The user consumption data 27 is any type of data captured or calculated that is indicative of utility consumption at the consumer premises including Popery A and B (FIG. 1A), Multiple Family Property C (FIG. 1B), or Hotel Property D (FIG. 1C). As an example, the user consumption data 27 may comprise data indicative of voltage measurements, current measurements and/or power calculations related to the Properties A, B, C, or D for determining usage details related to supplying of the utility.

In one embodiment, the user consumption data 27 is stored as user consumption data 27 keyed to unique identifiers associating the received data with particular measuring devices, e.g., measuring devices 11, 12, 116, 177, 126, or 127. In this regard, the user consumption data 27 comprises data indicative of utility readings received from the various utility equipment 2, 9, 114, 115, 124, and 115 associated with the meters that took the readings.

In one embodiment, the control logic 26 receives the user consumption data 27 from the third party data sources 3, 10. In response to such receipt, the control logic 26 stores the user consumption data 27 in memory 21. Note that user consumption data 27 is dynamic and is collected periodically by the third party data sources 3. As indicated hereinabove, the user consumption data 27 may include, but is not limited to, data indicative of current measurements, voltage measurements, and/or power calculations over a period of time if the utility being measured and provided is power. If gas or water, data indicative of measurements made regarding consumption by the Properties A, B, C, or D related to gas and water is contained within the user consumption data 27.

In another embodiment, the user consumption data 27 may be associated with an identifier (not shown) identifying the consumer premise, e.g., Property A, B, Multiple Family Property C, or Hotel Property D, from which the user consumption data 27 is collected. During operation, the control logic 26 periodically transmits the associated unique identifier and the periodically collected user consumption data 27 to the server computing device 6.

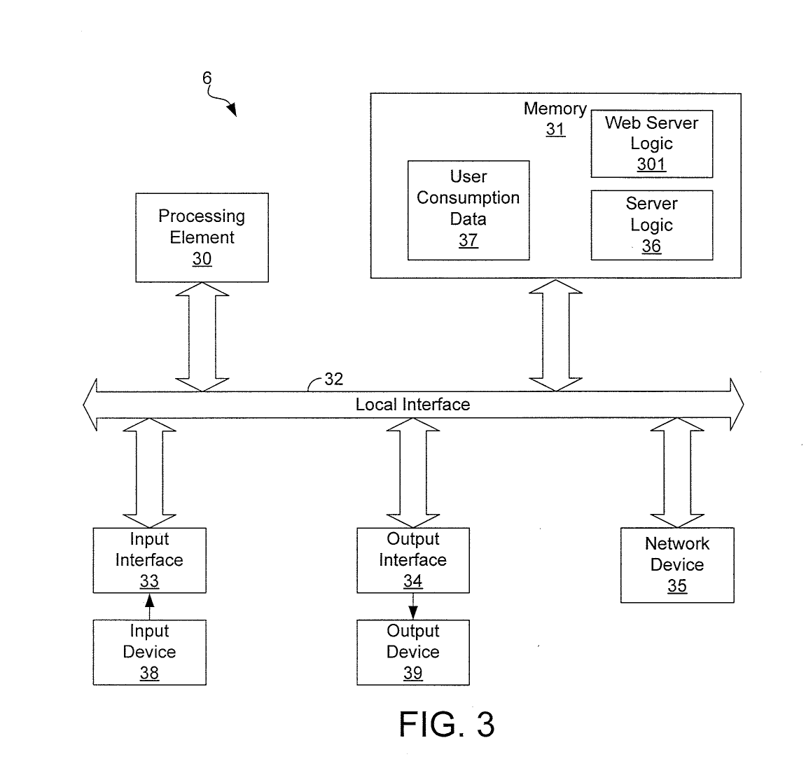

FIG. 3 depicts an exemplary embodiment of the server computing device 6 depicted in FIG. 1. As shown by FIG. 3, the server computing device 6 comprises server logic 36, web server logic 301 and user consumption data 37, which are stored in memory 31.

The server logic 36 generally controls the functionality of the server computing device 6, as will be described in more detail hereafter. It should be noted that the server logic 36 can be implemented in software, hardware, firmware or any combination thereof. In an exemplary embodiment illustrated in FIG. 3, the server logic 36 is implemented in software and stored in memory 31.

Note that the server logic 36, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the server computing 6 depicted by FIG. 3 comprises at least one conventional processing element 30, such as a digital signal processor (DSP) or a central processing unit (CPU) that communicates to and drives the other elements within the data retrieval computing device 4 via a local interface 32, which can include at least one bus. Further, the processing element 30 is configured to execute instructions of software, such as the server logic 36.

The web server logic 301 is software, hardware, firmware, or a combination thereof. The web server logic 301 controls and manages the transmission of files that form web pages, for example, at the client computing device 7. Service of such files to the client computing device is performed at the request of the pages from the client computing device 7, which is described further herein.

An input interface 33 may be communicatively coupled to an input device 38, for example, a keyboard, keypad, or mouse. The input interface 33 may be used to receive signals from the input device 38 indicative of input data from a user of the server computing device 6.

Further, an output interface 34 may be communicatively coupled to an output device 39, for example, a printer or display screen (e.g., a liquid crystal display (LCD)). The output interface 34 may be used to transmit signals to the output device 39 indicative of output data to the user.

In addition, a network device 35, such as a modem, enables the server computing device 6 to communicate via the network 5 (FIG. 1) to other devices communicatively coupled with the network 5. As an example, the network device 35 enables the server computing device 6 to transmit to and receive data from the data retrieval computing device 4 and the client computing device 7.

As indicated hereinabove, the user consumption data 37 is stored in memory 31. The user consumption data 37 is data receive from or calculated indicative of power consumption, water consumption, and/or gas consumption at the Properties A, B, C, or D (FIG. 1A-aC). In this regard, it may be the user consumption data 27 that is received from the data retrieval computing device 4 and/or data calculated from the user consumption data 27 received from the data retrieval device 4.

In one embodiment, the sever logic 36 receives the user consumption data 27 from the data retrieval device 4. In response to such receipt, the server logic 36 stores the user consumption data 27 as user consumption data 37 in memory 31.

As indicated hereinabove, the user consumption data 27 received from the data retrieval computing device 4 may comprise a unique identifier uniquely identifying the Property A, B, C, or D (FIG. 1) or the customer responsible for the consumer premise. Thus, the server logic 36 stores the received user consumption data 27 indexed with the corresponding unique identifier.

Note that in the system 1 (FIG. 1) there may be a plurality of data retrieval devices 4 communicatively connected to the network 5. Each data retrieval computing device 4 transmits it collected user consumption data 27 and transmits its user consumption data 27, along with its unique identifier, to the server computing device 6. The server logic 37 stores all the received user consumption data 27 in the user consumption data 37 indexed by the unique identifiers received.

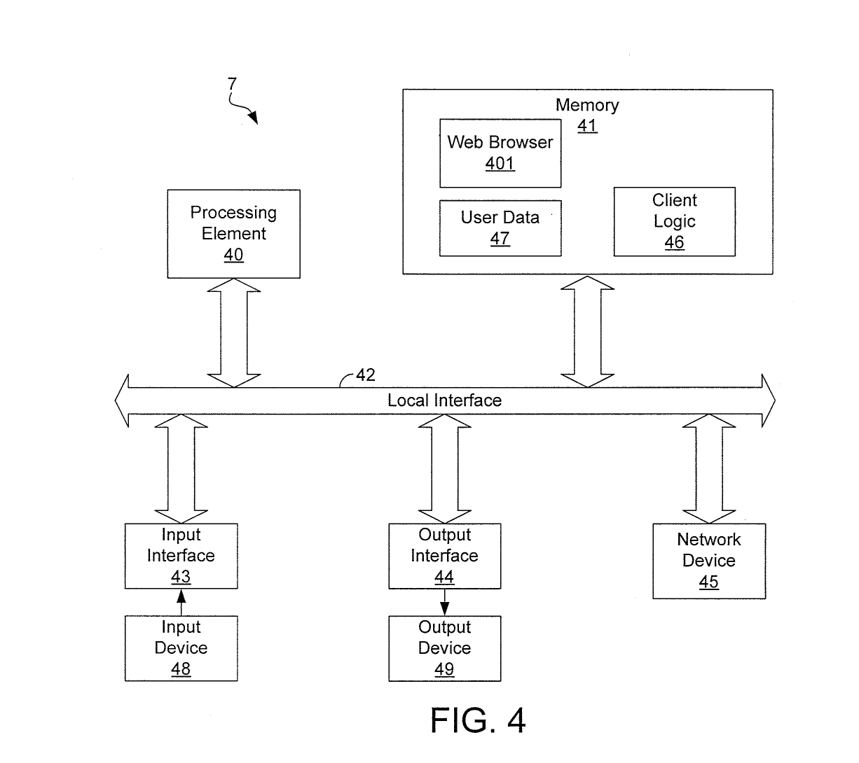

FIG. 4 depicts an exemplary embodiment of the client computing device 7 depicted in FIG. 1. As shown by FIG. 4, the client computing device 7 comprises client logic 46, a web browser, and user data 47, which are stored in memory 41.

The client logic 46 generally controls the functionality of the client computing device 7, as will be described in more detail hereafter. It should be noted that the client logic 46 can be implemented in software, hardware, firmware or any combination thereof. In an exemplary embodiment illustrated in FIG. 4, the client logic 46 is implemented in software and stored in memory 41.

Note that the client logic 46, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The web browser logic is software, hardware, firmware, or a combination thereof that is responsible for receiving and presenting files received from the web server logic 301 (FIG. 3).

The exemplary embodiment of the client computing 7 depicted by FIG. 4 comprises at least one conventional processing element 40, such as a digital signal processor (DSP) or a central processing unit (CPU) that communicates to and drives the other elements within the data retrieval computing device 4 via a local interface 42, which can include at least one bus. Further, the processing element 40 is configured to execute instructions of software, such as the client logic 46.

An input interface 43 may be communicatively coupled to an input device 48, for example, a keyboard, keypad, or mouse. The input interface 43 may be used to receive signals from the input device 48 indicative of input data from a user of the client computing device 7.

Further, an output interface 44 may be communicatively coupled to an output device 49, for example, a printer or display screen (e.g., a liquid crystal display (LCD)). The output interface 44 may be used to transmit signals to the output device 49 indicative of output data to the user.

In addition, a network device 45, such as a modem, enables the client computing device 7 to communicate via the network 5 (FIG. 1) to other devices communicatively coupled with the network 5. As an example, the network device 45 enables the client computing device 7 to transmit to and receive data from the server computing device 6.

As indicated hereinabove, the user data 47 is stored in memory 41. The user data 47 is data identifying a user of the client computing device 7, and user consumption data 37 (FIG. 3) received from the server computing device 6, and/or any input data received from the user via the input device 48.

Note that in the systems 1, 100, or 200 (FIG. 1A, 1B, or 1C) there may be a plurality of data retrieval devices 4 communicatively connected to the network 5, as indicated hereinabove. Thus, here may be a plurality of users and/or client computing devices 7. In this regard, a plurality of clients may use the client computing device 7 to receive data from and/or transmit data to the server computing device 6.

Note that the client logic 46 may be implemented in a variety of ways. For example, the client logic 46 may be a browser application that transmits data to and/or receives data from the server logic 36 (FIG. 3). In such an embodiment, the server logic 36 may generate data indicative of a graphical user interface (not shown) and transmit the data to the client logic 46. In response, the client logic 46 may display a graphical user interface (not shown) indicative of the data to the output device 49 via the output interface 44.

In another embodiment, the client logic 46 may be a standalone executable and data indicative of the graphical user interfaces for implementing the system 1 (FIG. 1) are stored locally on the client computing device 7. In such an embodiment, the client logic 46 may further be configured to dynamically retrieve data from the user consumption data 37 (FIG. 3) via communication with the server logic 36 (FIG. 3) and display such retrieved data to the graphical user interfaces that are rendered locally.

In one embodiment, the client computing device 7 may be a handheld device, such as for example an iPhone®. In such an embodiment, the client logic 46 may be an application that runs on the iPhone®, e.g., an “app,” that is accessible via selection of an icon displayed to the output device 49.

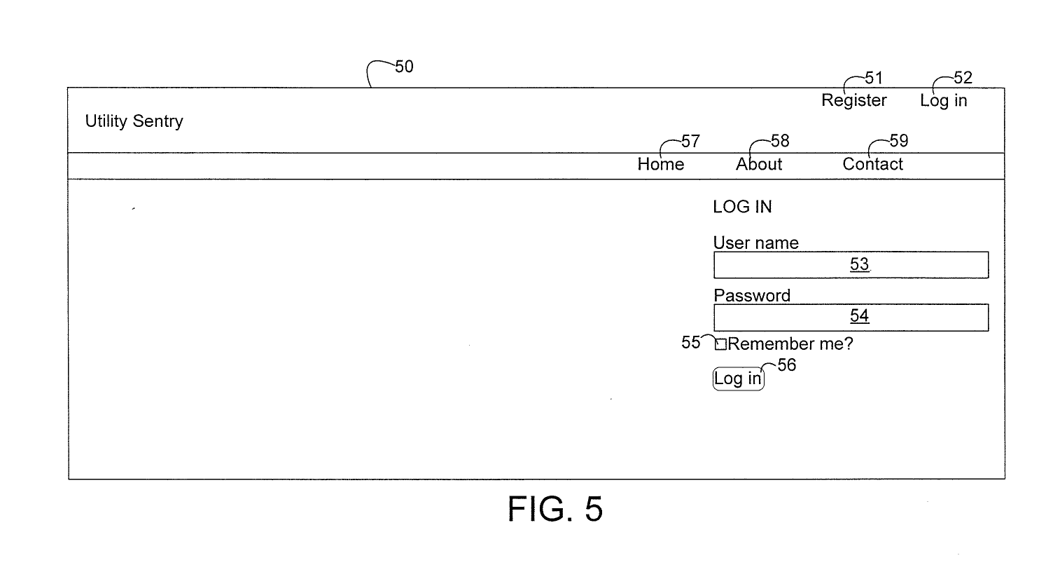

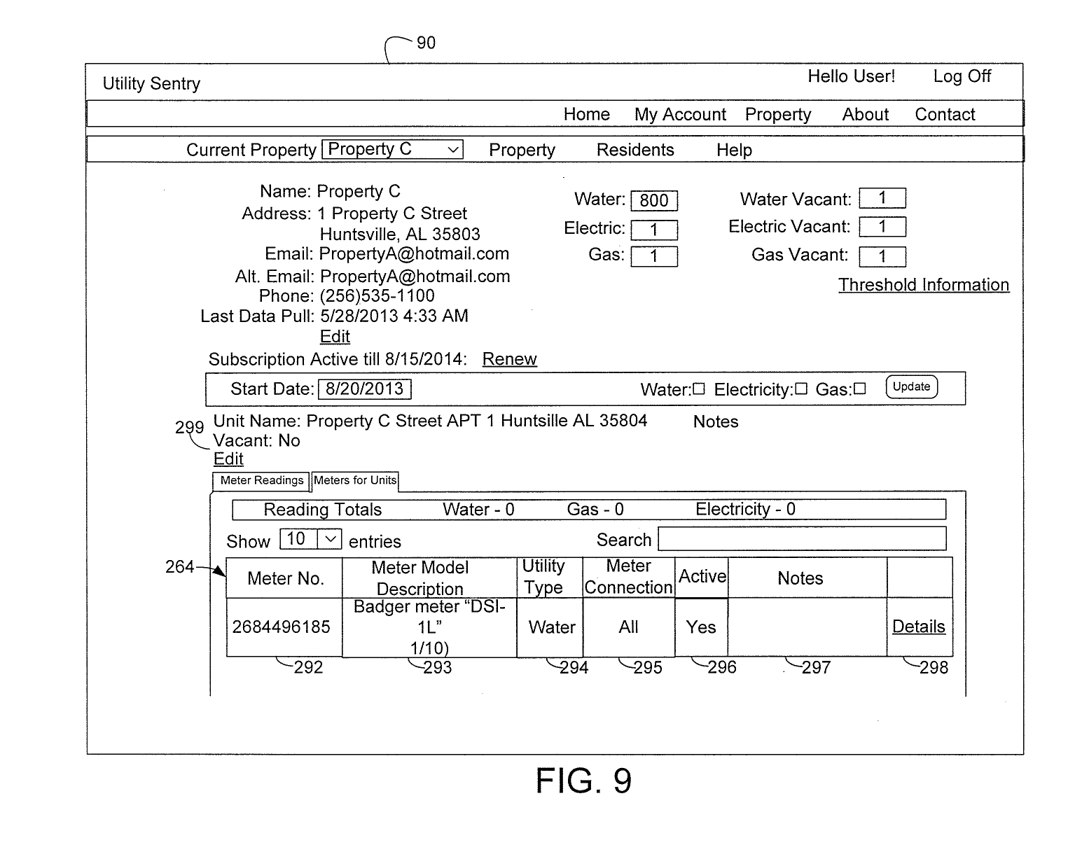

FIGS. 5-12 depict exemplary graphical user interfaces (GUIs) for implementing a system in accordance with an embodiment of the present disclosure. In one embodiment, the server logic 36 controls the receiving of the user consumption data 37 (FIG. 3), and the web server logic 301 (FIG. 3) generates data indicative of the described GUIs and transmits the data to the client computing device 7 (FIG. 1A).

Notably, the type of client computing device 7 used in an implementation of the system 1 of the present disclosure may vary depending upon the specific use of the system 1 for the current application.

During operation, a user logs onto the client computing device 7 by entering a unique username and a password. FIG. 5 depicts an exemplary login graphical user interface 50. The login GUI 50 comprises several artifacts including a “Register” hyperlink 51 and a “Log In” hyperlink 52.

When the “Register” hyperlink 51 is selected, the server logic 36 transmits data identifying a registration screen (not shown) via the web server logic 301 to the client computing device 7 (FIG. 1B). Note during registration, the user may identify for example, the properties that he/she desires to monitor and for which he/she desires to receive alerts. The user may also identify how alerts are to be sent.

When the “Log In” hyperlink 52 is selected, the server logic 36 transmits data identifying a log in screen as shown via the web server logic 301 to the client computing device 7 (FIG. 1B). The login screen comprises a “User Name” text field 53 and a “Password” text t field 54 in which the user enters his/her user name and password then selects a “Log in” pushbutton 56. Other artifacts on GUI 50 include a checkbox 55 so that the user does not have to enter his/her login information each time he/she logs into the system. In addition, there are navigation hyperlinks “Home” 54, “About” 58, and “Contact” 59 that can navigate the user to additional information.

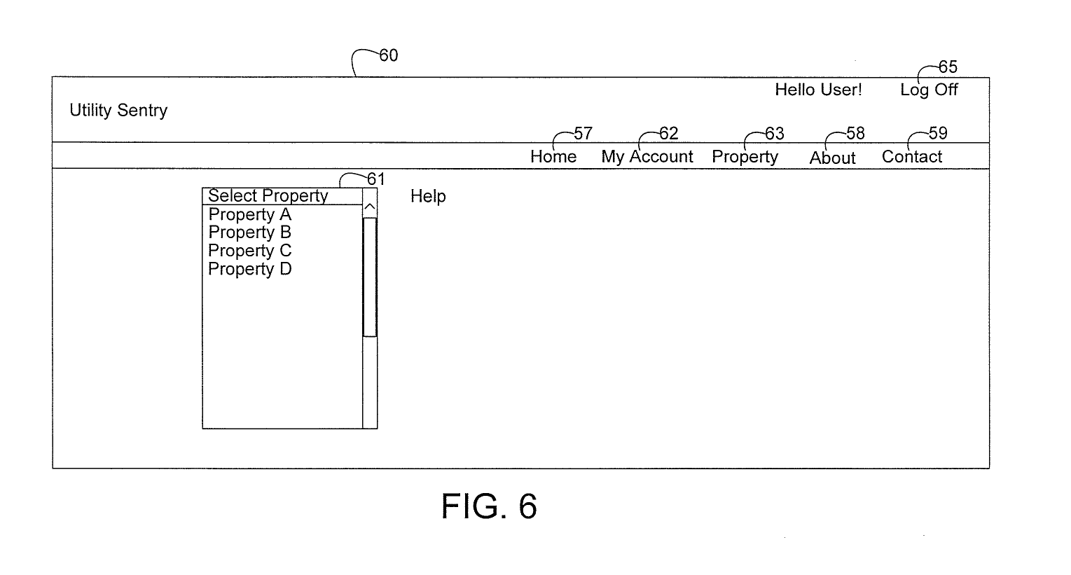

When the user logs in, in one embodiment, the user manages a number of properties. In such an embodiment, the client logic 46 displays a GUI 60 as shown in FIG. 6 that enables the user to select a property from a pull down list 61. In one embodiment, the pull down list 61 may be accessed from any other GUI so that the user may switch from one property to another with ease.

With reference to FIG. 6, there are four exemplary properties selected, including those shown in FIGS. 1A-1C, which are “Property A,” “Property B, “Property C”, and “Property D.” This particular user may access data related to all four properties.

Note that in GUI 60 there is a “Log Off” hyperlink 65 that when selected logs the user off the system. Further, there are user specific hyperlinks, including “Home” hyperlink 57, “My Account” hyperlink 62, “Property” hyperlink 63, “About” hyperlink 58, and “Contact” hyperlink 59.

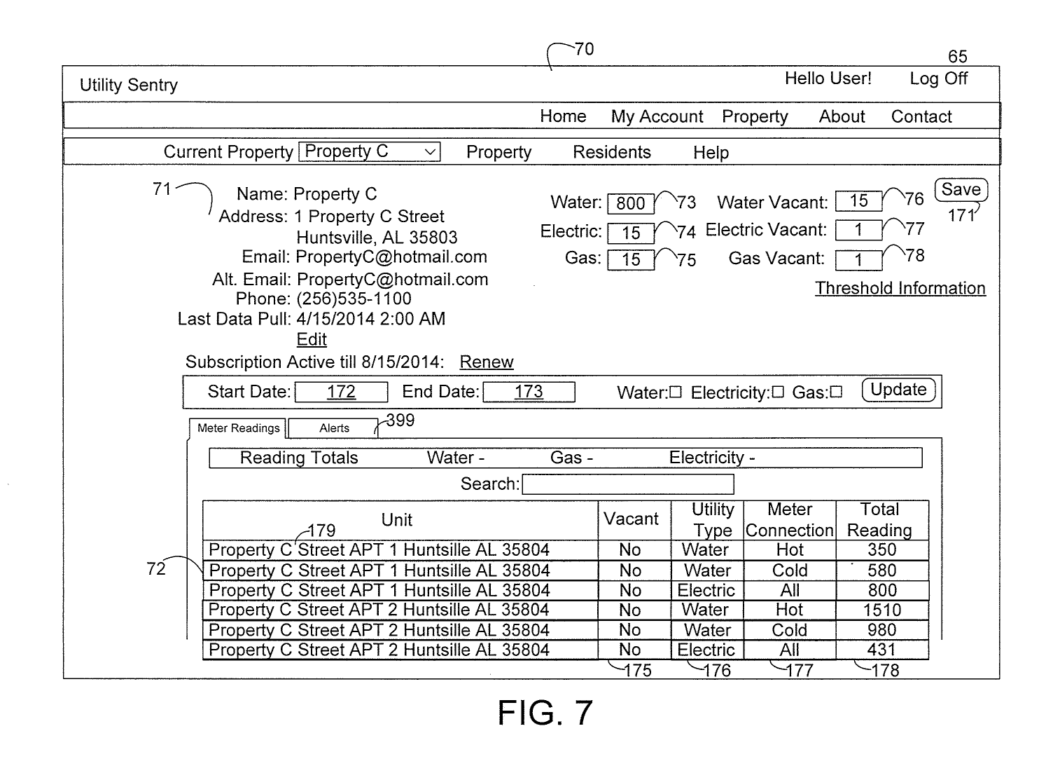

If a user selects Property C from the pull-down list 61, the web server logic 301 transmits data indicative of a Property Main GUI 70 and the web browser logic 401 displays GUI 70 depicted in FIG. 7. FIG. 7 provides an overview of the information available for the property.

Note that as shall be described, Property C is a multiple utility property type, as shown in FIG. 1B. In this regard, more than one type of utility is being monitored, e.g., water and electric. In other embodiments, fewer, e.g., one utility type, or more utility types may be monitored for the property. Further note that property C, as described with reference to FIG. 1B, is a multiple family property. Thus, once property C is selected from the pull-down 61 (FIG. 6), a listing for each family residence is listed corresponding to the utility being monitored as shown in FIG. 7, which is described more fully herein.

There is a property description section 71. In addition, for the present scenario the consumer premise Property C is an apartment building having a plurality of metering or measuring devices 116, 117 (FIG. 1B) and each sub-identifier of the property may be listed in a detail section 72, e.g., APT 1, 2, etc. For each identifier listed, the client logic 46 may display user consumption data 37 (FIG. 3) received from the server logic 36 (FIG. 3), which is stored as and retrieved from user data 47.

Notably, the GUI 70 comprises text fields 73-78 in which a user may specify threshold values. If the threshold values are exceeded, the client logic 46 may execute a warning or other action. To change the threshold values, the user enters data indicative of a new threshold in one of the text fields 73-78 then selects the “Save” pushbutton 171.

Further, in text fields 172 and 173, the user may enter a date range from which the user desires to view data. The control logic 25, in response, updates the data shown in the detail section 72 to reflect the dates requested by the user. The GUI 70 further has a “Vacant” column 175 where a user can toggle a “No” identifier to “Yes” indicating that an apartment has become vacant. A “Utility Type” column 176 identifies the type of utility being monitored. Note there may be more than one measuring device 115, 117 in each unit measuring the same utility, so two “water” utility markers may be identified. A “Meter Connection” column 176 identifies the meter connection type for each meter, and a “Total Reading” column 178 identifies the total sum of usage for the date range indicated by the utility type for each unit listed.

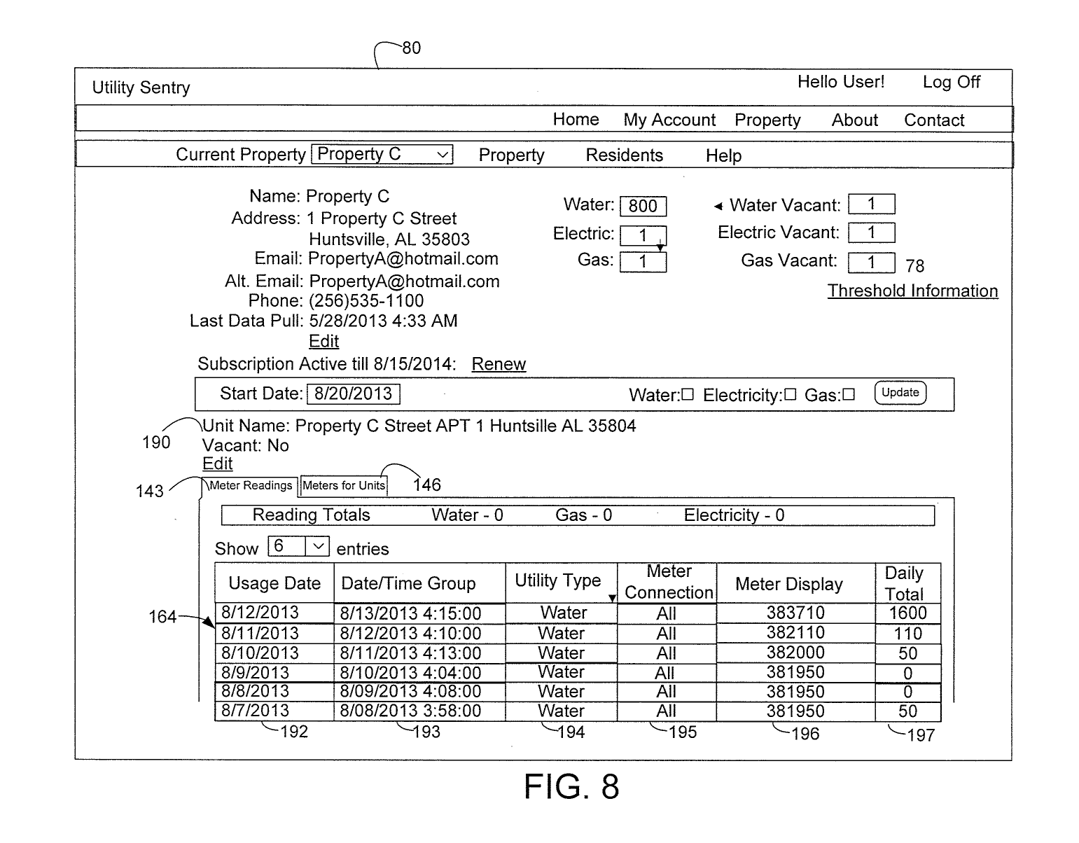

FIG. 8 is an exemplary Unit/Resident GUI 80 that is displayed by the client logic 46 to show details related to a specific unit/resident when, for example, the link 179 (FIG. 7) is selected by the user. This particular GUI 80 is displayed correlated with the “Meter Readings” tab 143. In this regard, the GUI 80 displays a list of meter readings 164 taken for the residence shown in section 190.

Notably, the data shown in section 190 is related specifically to the unit/residence selected in FIG. 7, i.e., Property C Street, Apartment 1. Further, GUI 80 comprises the text fields 73-76 in which the user may specify threshold values for the identified unit in section 199.

GUI 80 comprises a listing 164 for the particular unit identified in section 190. There is a “Usage Date” column 192 that gives a list of dates for which readings were taken, and for each date listed there is a corresponding “Date/Time Group” column 193 showing the time the reading was taken, a “Utility Type” column 194 that indicates the type of utility meter corresponding to the reading, and a “Meter Connection” column 195 that indicates the meter connection type. In addition, the GUI 80 comprises a “Meter Display” column 196 that shows the quantity of the utility used and a “Daily Total” column 197 that shows the total for the day the reading was taken.

A user may desire to get specific meter details about a particular meter for the currently selected unit or residence, thus the user selects the “Meters for Unit” tab 146. Upon selection, the control logic 46 displays GUI 90 to display meter-specific information. GUI 90 comprises a section 299 naming the unit or residence. In addition, there is a table 264 having a “Meter No.” column 292 that displays the identifier of the meter being described, a “Meter Model Description” column 293 describing the meter, a “Utility Type” column 294 showing the utility type associated with the listed meter, a “Meter Connection” column 295 showing the meter connection type, an “Active” column 296 stating whether the meter is active, a “Notes” column 297 for use by the user for notes related to the particular meter, e.g., location information may be inserted in this column, and a “Details” hyperlink 298 to navigate to details regarding the reading.

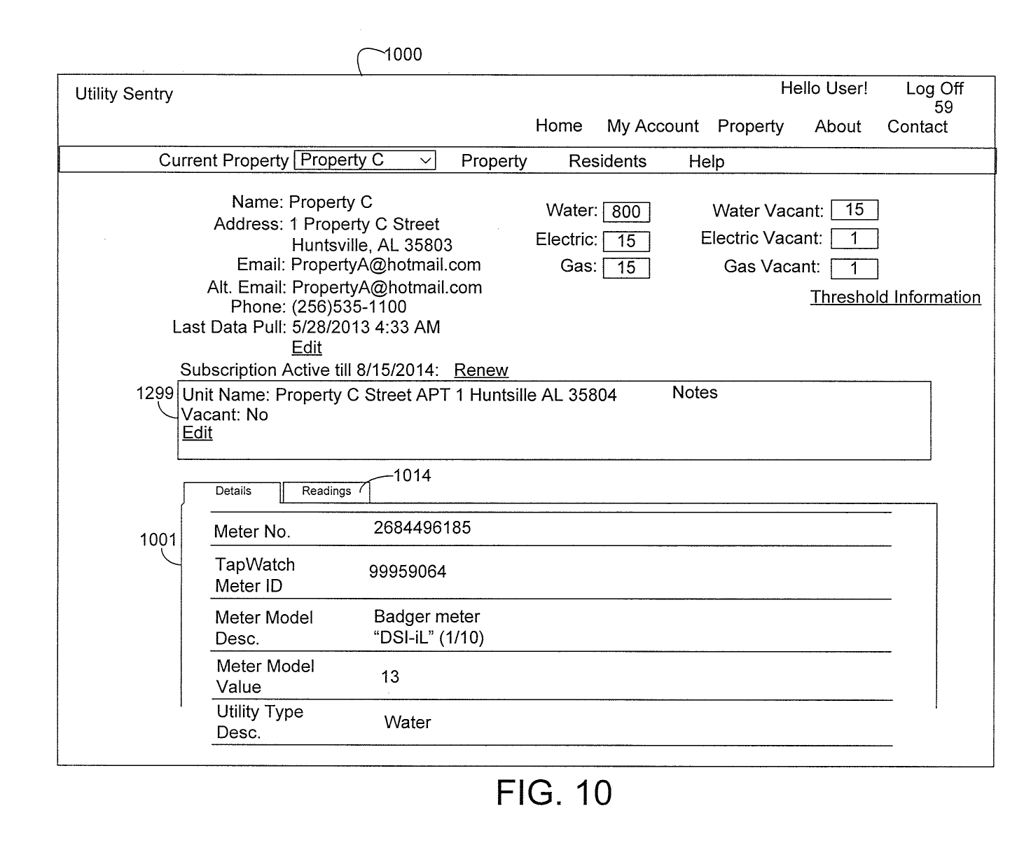

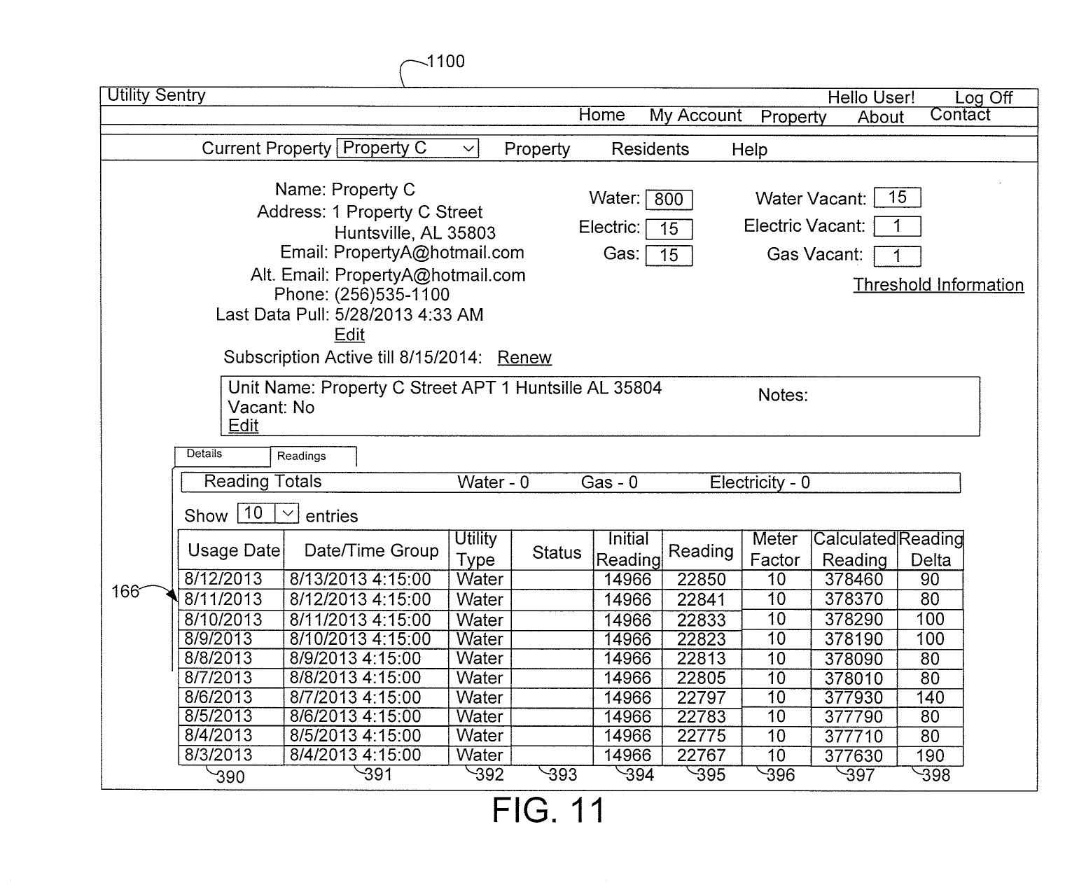

If the user selects the “Details” link 298, the control logic 46 displays GUI 1000 shown in FIG. 10. GUI 1000 displays data indicative of the meter in section 1001, and by selecting the “Readings” tab 1014, the control logic 46 displays GUI 1100 depicted in FIG. 11.

Meter reading GUI 1100 displays a list 166 of data acquired for meter readings collected by the third party data sources 110, 113 (FIG. 1B). The table 166 comprises a “Usage Date” column 390 showing the date of usage of the utility. Further, it comprises a “Date/Time Group” column 3911 showing when the reading was taken, a “Utility Type” column 392 showing the type of utility, and a “Status” column 393 for reporting status information related to the reading. In addition, the table 166 comprises the data received during a reading, including an “Initial Reading” column 394 and a “Reading” column 395. The table 166 further comprises a “Meter Factor” column 396, a “Calculated Reading” column 397, and a “Reading Delta” column 398.

Note that various messages may be displayed in the “Status” column 393. As mere examples, if there was a loss in communications then the status column may display data indicative of the average data total of usage for the dates in which communication was down. Another example is that the meter may be periodically serviced and in response the readings may change. If so, the “Status” column 383 may display “Serviced.”

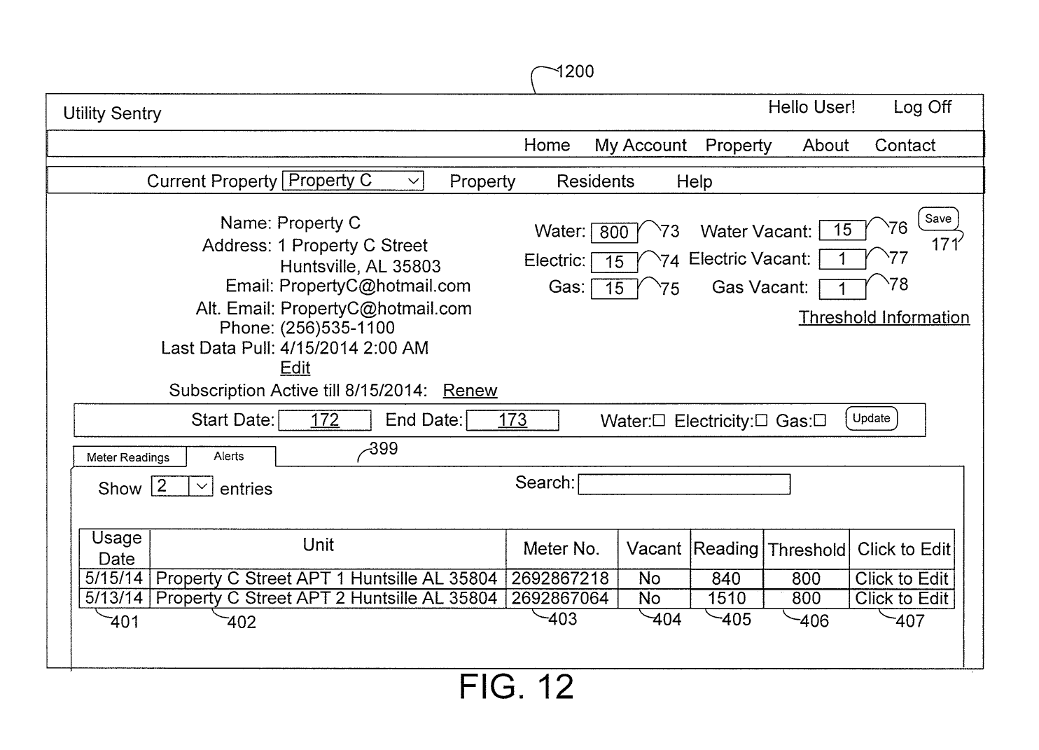

If the user selects the “Alerts” tab 399 (FIG. 7), the control logic 46 displays the Alert GUI 1200 depicted in FIG. 12. The GUI 1200 shows a listing of alerts that have been issued. In this regard, if thresholds are defined by the user in text fields 73-78 (FIG. 7), the client logic 46 stores such information in the user data 47. If the user consumption data 27 (FIG. 2) indicative of readings from meters from units/residences exceed the threshold, the control logic 46 may send a transmission, which is discussed further herein, and log the threshold exception.

The exemplary GUI 1200 shows two threshold exceptions on May 15, 2014 and May 13, 2014 in the “Usage Date” column 401. Corresponding to each threshold exception is a property that exceeded the threshold in “Unit” column 402, a meter number in a “Meter No.” column 403, and a “Vacant” column 404. Also corresponding to the exception, there is a “Reading” column 405 that identifies the reading that necessitated the exception and a corresponding threshold in the “Threshold” column 406. In one embodiment, the GUI 1200 further comprises a “Click to Edit” column 407. Once maintenance has been performed for the unit that exceeded the threshold level, the user can click the “Click to Edit” links and insert notes regarding follow up regarding the threshold exception.

Note as described hereinabove, the logic 46 places the threshold exception on the Alert GUI 1200 as depicted in FIG. 12. In addition, the logic 46 can transmit a message in a number of ways notifying administration that a unit or residence has exceeded a set threshold. In this regard, the logic 46 may send an email, a text message, or place a phone call with an automated message that alerts one to the threshold exception.

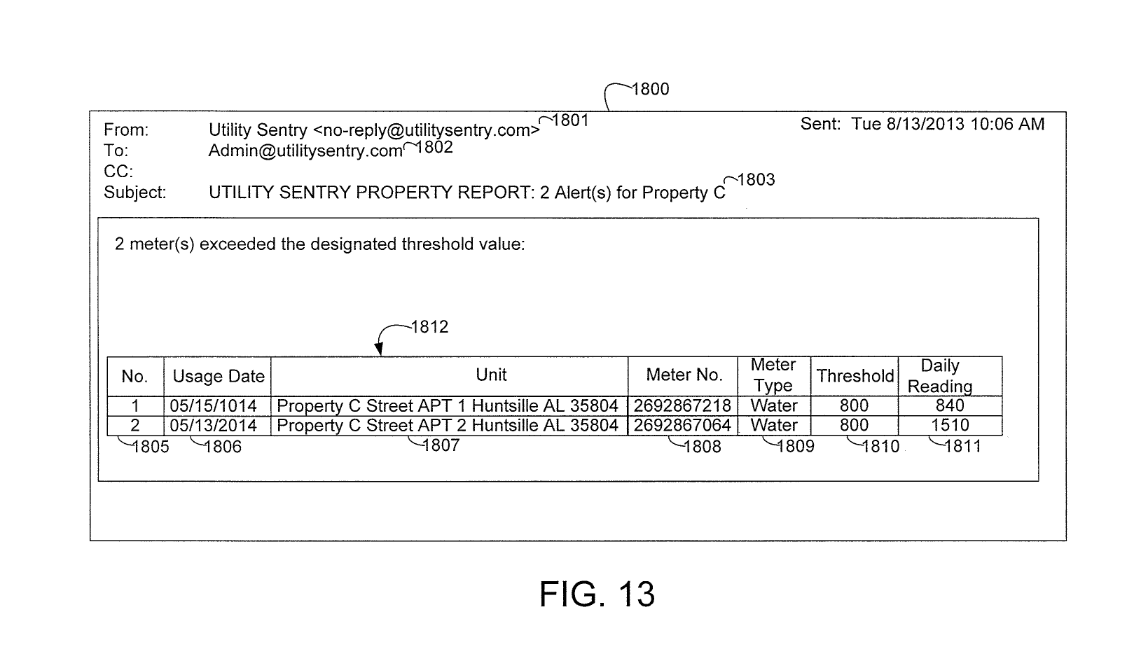

FIG. 13 depicts an exemplary email 1800 that the server logic 36 (FIG. 3) may transmit in response to the threshold exceptions depicted in FIG. 12. Notably, the server logic 36 may transmit an email to a recipient 1801 noting the sender 1802. The subject line 1803 reads “UTILITY SENTRY PROPERTY REPORT: 2 Alert(s) for Property C,” which corresponds to the two threshold exceptions depicted in FIG. 12.

The exemplary GUI 1300 comprises an alert table 1812 that comprises seven columns. The table 1812 comprises a “No.” column 1805 to depict the number of alerts and identify each particular alert. Further, the table 1812 comprises a “Usage Date” column 1806 to identify the date of the threshold exception, a “Unit” column 1807 to identify the unit that experienced the threshold exception, and a “Meter No.” column 1808 to identify the particular meter that experienced the exception. Additionally, the table 1812 comprises a “Meter Type” column 1809 to identify the type of meter that experienced the exception, a “Threshold” column 1810 to indicate the threshold presently set for the particular meter (e.g., in the text fields 73-78 (FIG. 7)), and a “Daily Reading” column 1811 to identify that actual reading that caused the exception.

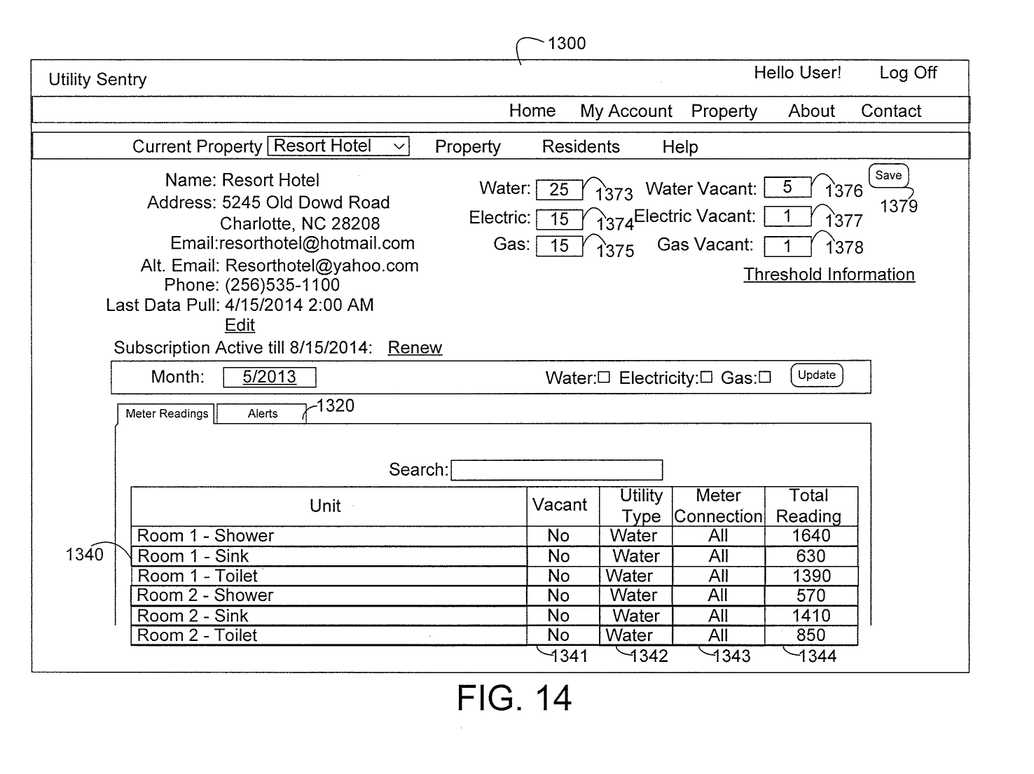

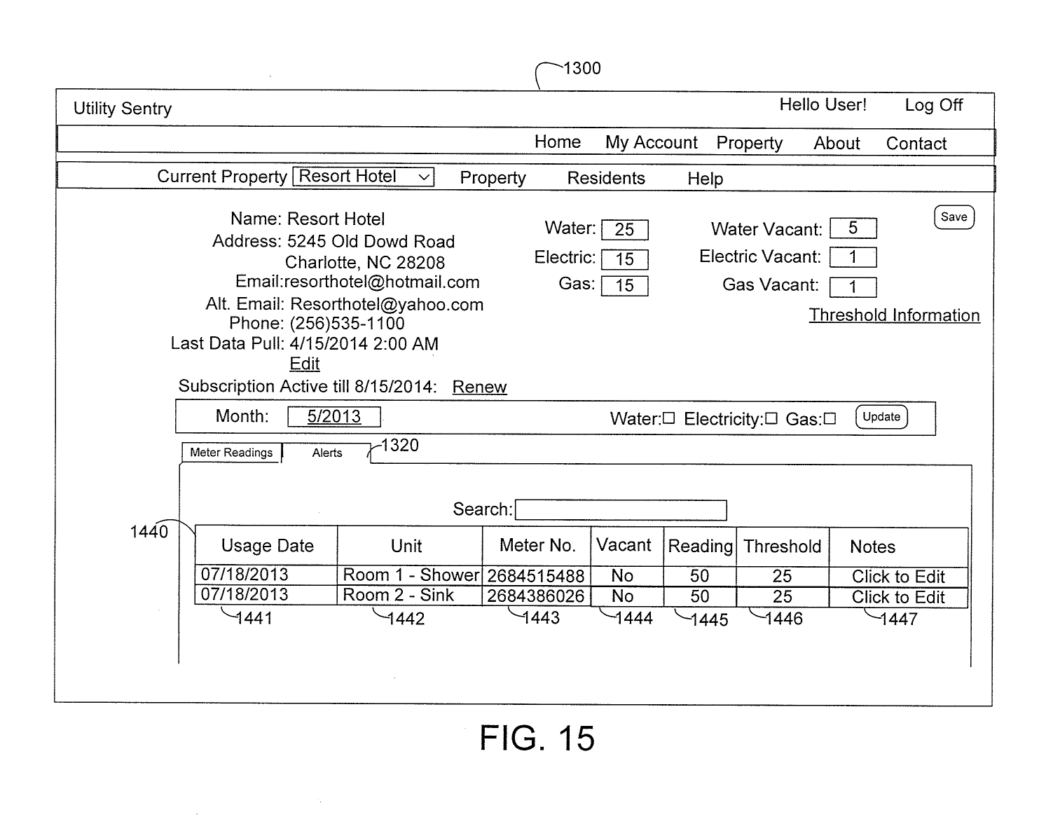

As described with reference to FIG. 1C, the property to be managed may be a hotel that comprises a plurality of rooms. For simplicity, Property D has two rooms, including Room 1 and Room 2. FIGS. 14 and 15 depict an implementation of GUIs for use in the present disclosure via the server computing device 6 and the client computing device 7 in relation to a hotel property, e.g., Property D depicted in FIG. 1C.

FIG. 14 depicts a main property GUI 1300 for the hotel Property D (FIG. 1C). The GUI 1300 comprises threshold text fields 1373-1378 for water, electric, gas, water when vacant, electric when vacant, and gas when vacant, respectively, similar to the main property GUI 70 (FIG. 7). The user of the GUI 1300 sets such thresholds by entering data indicative of the thresholds in the corresponding text fields 1373-1378. In the exemplary GUI shown, water is set at 115, electric is set at 15, gas is set at 1375, Water when vacant is set at 5, electric when vacant is set at 1, and gas when vacant is set at 1.

The GUI comprises a listing 1340 of the various utility implements that are being monitored. In this regard, in the hotel setting, measuring devices may be coupled directly to the implements, for example the shower, the sink, and the toilet. Such measuring devices may then communicate with the third party data source 120 (FIG. 1C). As described hereinabove with reference to the meters, each of the implements may be configured with a unique identifier either at manufacture or installation. Thus, when the measuring devices 126, 127 that are coupled to the implements transmit data, such unique identifier may be included in the data for correlating the data with the particular implement.

In the example shown, there are two rooms, Room 1 and Room 2, and each room has a shower, sink, and toilet. For each of these implements, there is a “Vacant” column 1341 to indicate whether the room is vacant, a “Utility Type” column 1342 to indicate the type of utility being monitored, a “Meter Connection” column 1343, and a “Total Reading” column 1344.

If tab 1320 is selected, the control logic 46 displays the GUI 1400 depicted in FIG. 15. GUI 1400 comprises a table 1440 that lists the threshold exceptions for the rooms in Property D. In this regard, table 1440 comprises a “Usage Date” column 1441, a “Unit” column 1442 that identifies the unit and the implement, a “Meter No.” column 1443 that displays the identifier of the measuring device 125, 127 (FIG. 1C), a “Vacant” column 1444, a “Reading” column 1445 that shows the current reading that exceeded the threshold, a corresponding “Threshold” column 1446 that identifies the current threshold setting, and a “Notes” column 1447 in which the user can enter notes related to the overage.

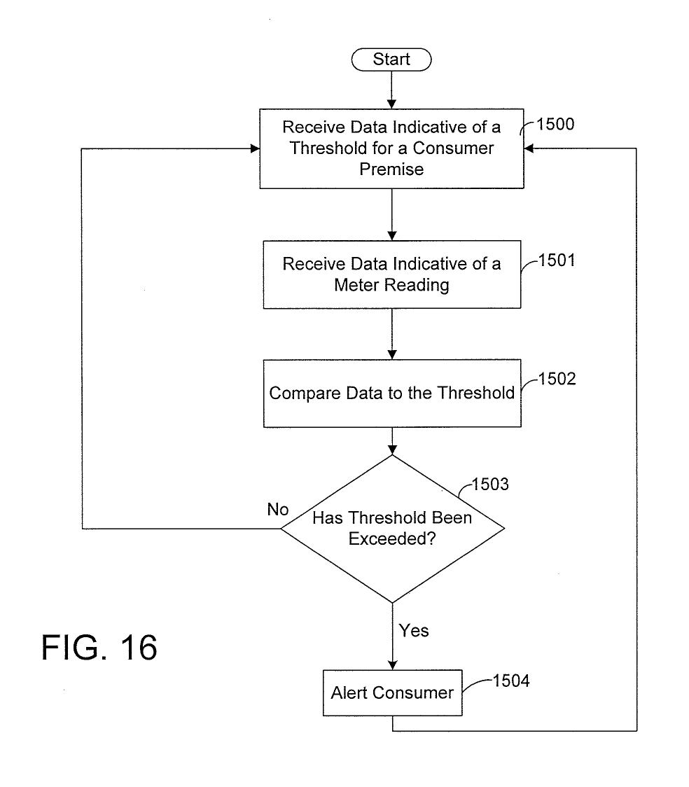

FIG. 16 is a flowchart depicting exemplary architecture and functionality of the server logic 36 (FIG. 3). In such an embodiment, the server logic 36 receives data indicative of a threshold for a property or a particular utility fixture in step 1500. In step 1501, the control logic 36 receives data indicative of a meter reading and in step 1502 compares the threshold to the reading. If the reading exceeds the threshold in step 1203, the control logic 36 alerts the consumer in step 1504.

Note that the server logic 36 or the client logic 46 may perform the functions described hereinabove with respect to the system 1. If the system 1 comprises client logic 46 that is a web-based implementation, then calculations, threshold comparisons, and other determinations are performed by the server logic 36.

1. An energy equipment monitoring and reporting system, comprising:
a property comprising at least one utility;
a third party data source coupled to the at least one utility, the third party data source configured for receiving measurement data indicative of utility consumption; and
a data retrieval computing device configured to retrieve measurement data from the third party data source and transmit the measurement data to a server computing device via a network.

2. The energy equipment monitoring and reporting system of claim 1, further comprising a client computing device communicatively coupled to the server computing device.

3. The energy equipment monitoring and reporting system of claim 2, wherein the client computing device further comprises logic configured to display the measurement data to a display device.

4. The energy equipment monitoring and reporting system of claim 3, wherein the logic is further configured to receive data indicative of a usage threshold from a user.

5. The energy equipment monitoring and reporting system of claim 4, wherein the logic is further configured to transmit a notification if the measurement data meets or exceeds the usage threshold.

6. The energy equipment monitoring and reporting system of claim 2, further comprising a plurality of utilities wherein each utility is associated with a particular room of a facility.

7. The energy equipment monitoring and reporting system of claim 6, wherein the logic is further configured to display receive measurement data for each of the plurality of utilities.

8. The energy equipment monitoring and reporting system of claim 7, wherein the logic is further configured to display measurement data indicative of a the utility of one of the particular rooms based upon selection by a user.

9. The energy equipment monitoring and reporting system of claim 2, further comprising a plurality of properties wherein each of the properties comprises at least one utility.

10. The energy equipment monitoring and reporting system of claim 9, wherein the logic is further configured to display measurement data for at least one of the plurality of properties based upon a selection of one of the plurality of the properties by the user.

11. An energy equipment monitoring and reporting method, comprising:
providing a property comprising at least one utility;
receiving, by a third party data source, measurement data indicative of utility consumption; and
retrieving, by a data retrieval computing device, measurement data from the third party data source and transmit the measurement data to a server computing device via a network.

12. The energy equipment monitoring and reporting method of claim 11, further comprising transmitting measurement data to a client computing device communicatively coupled to the server computing device.

13. The energy equipment monitoring and reporting method of claim 12, further comprising displaying the measurement data to a display device of the client computing device.

14. The energy equipment monitoring and reporting method of claim 13, further comprising receiving data indicative of a usage threshold from a user via the client computing device.

15. The energy equipment monitoring and reporting method of claim 14, further comprising transmitting a notification if the measurement data meets or exceeds the usage threshold.

16. The energy equipment monitoring and reporting method of claim 12, further comprising providing a plurality of utilities wherein each utility is associated with a particular room of a facility.

17. The energy equipment monitoring and reporting method of claim 16, further comprising displaying received measurement data for each of the plurality of utilities.

18. The energy equipment monitoring and reporting method of claim 17, further comprising displaying measurement data indicative of a utility of one of the particular rooms based upon selection by a user.

19. The energy equipment monitoring and reporting method of claim 12, further comprising providing a plurality of properties wherein each of the properties comprises at least one utility.

20. The energy equipment monitoring and reporting method of claim 19, further comprising displaying measurement data for at least one of the plurality of properties based upon a selection of one of the plurality of the properties by the user.
